(19) United States
(12) Patent Application Publication
(10) Pub. No.: US 2023/0412989 A1
(43) Pub. Date: Dec. 21, 2023

(54) CMUT TRANSDUCER AND METHOD FOR MANUFACTURING A CMUT TRANSDUCER

(71) Applicant: VERMON SA, Tours (FR)

(72) Inventors: Youngil KIM, Tours (FR); Cyril MEYNIER, Tours (FR); Dominique GROSS, Tours (FR); Jacques HELLER, Tours (FR); Nicolas SENEGOND, Tours (FR)

(21) Appl. No.: 18/320,000

(22) Filed: May 18, 2023

(30) Foreign Application Priority Data
May 23, 2022 (FR) 2204899

(51) Int. Cl. H04R 19/00; H04R 31/00; H04R 17/10

(52) U.S. Cl. CPC H04R 19/005; H04R 17/10; H04R 31/006

(57) ABSTRACT

A method of manufacturing a CMUT transducer includes: a) forming a first silicon oxide layer on a face of a first silicon layer defining a first electrode of the transducer; b) forming a second silicon oxide layer on a face of a second silicon layer; c) subsequent to step a), forming, at the side of said face of the first silicon layer, by locally oxidizing the silicon of the first silicon layer, silicon oxide walls; and d) subsequent to steps b) and c), transferring and attaching the set comprising the second silicon layer and the second silicon oxide layer on the set comprising the first silicon layer, the first silicon oxide layer, and the silicon oxide walls.

### TECHNICAL FIELD

The present disclosure generally relates to the field of ultrasonic transducers, and more particularly to that of membrane capacitive ultrasonic transducers, also called CMUT (“Capacitive Micromachined Ultrasonic Transducer”) transducers.

### BACKGROUND ART

Usually, a CMUT transducer comprises a flexible membrane suspended on a cavity, a first electrode, called lower electrode, located at the side of the cavity opposite to the membrane, and a second electrode, called upper electrode, located at the side of the cavity opposite to the first electrode and mechanically fixed to the flexible membrane. Operatively, a dc biasing voltage is applied between the electrodes. When a suitable ac excitation voltage, superimposed on the dc biasing voltage, is applied between the electrodes, the flexible membrane goes vibrating under the influence of the change of the electrostatic force applied between the electrodes, causing the transmission of an ultrasonic sound wave. Oppositely, when the transducer receives an ultrasonic sound wave, the flexible membrane goes vibrate under the influence of the change of the mechanical pressure, driving to the occurrence, between the lower and upper electrodes of the transducer, of an ac voltage superimposed on the dc biasing voltage, because of the change of the capacitance between the electrodes.

A CMUT transducer is usually coupled with a control electronic circuit configured to, during a transmission phase, apply between the electrodes of the transducer an excitation ac voltage superimposed on a dc biasing voltage, so as to cause the transducer to transmit an ultrasonic sound wave, and, during a receiving phase, to apply between the electrodes of the transducer a dc biasing voltage and read between said electrodes an ac voltage generated under the influence of a received ultrasonic sound wave.

The transmission frequency of a CMUT transducer is generally related to its resonant frequency that depends on various parameters, and particularly on geometrical and mechanical characteristics of the membrane, and of the cavity, as well as on the external environment.

It would be desirable to be able to dispose of a CMUT transducer and of a method for manufacturing such a transducer, addressing all or some of the drawbacks of the known CMUT transducers and methods for manufacturing CMUT transducers.

### SUMMARY OF INVENTION

One embodiment provides a method of manufacturing a CMUT transducer, comprising the following steps:

a) forming a first silicon oxide layer on a face of a first silicon layer defining a first electrode of the transducer;
b) forming a second silicon oxide layer on a face of a second silicon layer;
c) subsequent to step a), forming at the side of said face of the first silicon layer, by locally etching the silicon of the first silicon layer, silicon oxide walls having a height higher than the thickness of the first silicon oxide layer, said walls laterally delineating a cavity of the transducer; and
d) subsequent to steps b) and c), transferring and attaching the set comprising the second silicon layer and the second silicon oxide layer on the set comprising the first silicon layer, the first silicon oxide layer, and the silicon oxide walls, so as to close the cavity of the transducer, said cavity vertically extending from the face of the first silicon oxide layer opposite to the first silicon layer to the face of the second silicon oxide layer opposite to the second silicon layer.

According to an embodiment, in step a), the first silicon oxide layer is formed by dry-growing thermal oxidizing said face of the first silicon layer, and, in step b), the second silicon oxide layer is formed by dry-growing thermal oxidizing said face of the second silicon layer.

According to an embodiment, step c) comprises a step of depositing a silicon nitride layer on the face of the first silicon oxide layer opposite to the first silicon layer, followed with a step of locally etching the silicon nitride layer and the first silicon oxide layer at the desired locations of the silicon oxide walls, followed with a step of thermally oxidizing so as to form the silicon oxide walls, followed with a step of removing the silicon nitride layer.

According to an embodiment, removing the silicon nitride layer is performed by wet etching.

According to an embodiment, in step d), the set comprising the second silicon layer and the second silicon oxide layer is attached on the set comprising the first silicon layer, the first silicon oxide layer, and the silicon oxide walls by direct bonding.

According to an embodiment, the direct bonding implemented in step d) comprises an annealing at a temperature comprised between 700 and 1,100° C.

According to an embodiment, the direct bonding implemented in step d) is a bonding of the face of the second silicon oxide layer opposite to the second silicon layer on the face of the silicon oxide walls opposite to the first silicon oxide layer.

According to an embodiment, the first silicon layer is a fixed substrate, and the second silicon layer is a flexible membrane of the transducer.

According to an embodiment, the thickness of the first silicon oxide layer is substantially equal to the thickness of the second silicon oxide layer.

According to an embodiment, the method further comprises steps of forming, on the face of the first silicon layer opposite to the first silicon oxide layer, contact metallization of the transducer, and a step of connecting said contact metallization to a control integrated circuit of the transducer.

According to an embodiment, the first silicon layer is doped.

According to an embodiment, the method comprises a step of forming, on a face of the second silicon layer opposite to the second silicon oxide layer, a metal layer defining a second electrode of the transducer.

Another embodiment provides a CMUT transducer comprising:
a first silicon layer defining a first electrode of the transducer;
a first silicon oxide layer disposed on and contacting the upper face of the first silicon layer;
silicon oxide localized walls vertically extending higher than the upper face of the first silicon oxide layer and partially entering the first silicon layer, said walls laterally delineating a cavity of the transducer;
a second silicon oxide layer closing the cavity at its upper face, the cavity vertically extending from the upper face of the first silicon oxide layer to the lower face of the second silicon oxide layer; and
a second silicon layer disposed on and contacting the upper face of the second silicon oxide layer.

### BRIEF DESCRIPTION OF DRAWINGS

The foregoing features and advantages, as well as others, will be described in detail in the following description of specific embodiments given by way of illustration and not limitation with reference to the accompanying drawings, in which:

FIG. 1A, FIG. 1B, FIG. 1C, FIG. 1D, FIG. 1E, FIG. 1F, FIG. 1G, FIG. 1H, and FIG. 1I are cross-sectional views illustrating consecutive steps of an example of a method for manufacturing CMUT transducers according to an embodiment;

FIG. 2A, FIG. 2B, FIG. 2C, FIG. 2D, and FIG. 2E are cross-sectional views illustrating consecutive steps of another example of a method for manufacturing CMUT transducers according to an embodiment;

FIG. 2F is a cross-sectional view illustrating an alternative embodiment of the device of FIG. 2E; and

FIG. 3 is a cross-sectional view illustrating another alternative embodiment of the device of FIG. 2E.

### DESCRIPTION OF EMBODIMENTS

Like features have been designated by like references in the various figures. In particular, the structural and/or functional features that are common among the various embodiments may have the same references and may dispose identical structural, dimensional and material properties.

For the sake of clarity, only the operations and elements that are useful for an understanding of the embodiments described herein have been illustrated and described in detail. In particular, the various applications the described transducers may have, were not detailed, the described embodiments being consistent with the usual applications of ultrasonic transducers, particularly in ultrasonic imaging devices. Further, the control circuits of the described transducers were not detailed, the described embodiments being consistent with all or most of the known control circuits of CMUT transducers.

In the present disclosure, unless indicated otherwise, we call CMUT transducer a device constituted of one or more CMUT transduction elements disposed according to the requirements of the application. Each CMUT transduction element is constituted of one or more CMUT transduction elementary cells electrically connected to each other, for example in parallel. Each CMUT elementary cell for example comprises a single flexible membrane suspended on a cavity, and two opposed electrodes adapted to receive an electrical excitation signal to vibrate the membrane and/or to generate an electrical response signal under the influence of a vibration of the membrane.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless indicated otherwise, when reference is made to absolute positional qualifiers, such as the terms “front”, “back”, “top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation shown in the figures.

Unless specified otherwise, the expressions “around”, “approximately”, “substantially” and “in the order of” signify within 10%, and preferably within 5%.

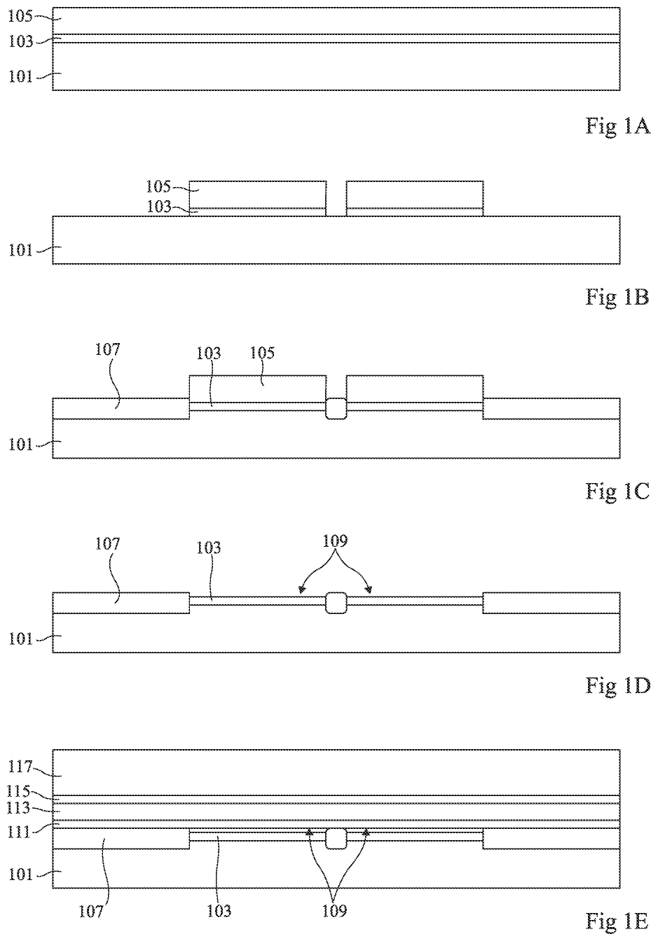

FIGS. 1A to 1I are cross-sectional views illustrating consecutive steps of an example of a method for manufacturing CMUT transducers according to an embodiment. In FIGS. 1A to 1I, the embodiment of a single elementary cell of CMUT transducer was represented. Practically, a large number of cells may be simultaneously implemented from a same initial substrate.

FIG. 1A is a cross-sectional view illustrating the structure obtained at the end of a step of forming, on an initial silicon substrate 101, a silicon oxide layer 103, then a silicon nitride layer 105. The substrate 101 is preferably relatively highly doped. As an example, the substrate 101 is a silicon substrate with a doping level comprised between 1013 and 1018 atoms/cm3. The thickness of the substrate 101 is for example comprised between 30 μm and 1 mm, for example between 400 and 800 μm. The substrate 101 for example corresponds to a silicon wafer, or to a portion of silicon wafer. One should note that the substrate 101 may optionally be thinned at the end of the method.

The silicon oxide layer 103 is formed on and contacting the upper face of the substrate 101. The layer 103 is for example formed by dry-growing thermal oxidizing so as to obtain a high quality oxide. The layer 103 for example continuously extends and with a substantially uniform thickness on the whole upper surface of the substrate 101. The thickness of the layer 103 is for example comprised between 20 and 300 nm, for example between 100 and 150 nm, for example in the order of 125 nm.

The silicon nitride layer 105 is for example deposited on and contacting the upper face of the layer 103. The layer 105 for example continuously extends and with a substantially uniform thickness on the whole upper surface of the substrate 101. The layer 105 is for example deposited by vapor phase chemical deposition, for example by LPCVD (Low Pressure Chemical Vapor Deposition), which has the advantage not to deteriorate the quality of the underlying silicon oxide layer 103. Alternatively, the layer 105 may be deposited by PECVD (Plasma Enhanced Chemical Vapor Deposition), or by any another appropriate deposition process. The thickness of the layer 105 is for example comprised between 50 and 500 nm, for example between 100 and 300 nm, for example in the order of 200 nm.

FIG. 1B illustrates the structure obtained at the end of a step of locally etching the stack formed by the layers 103 and 105. In this example, the layers 103 and 105 are kept in place only in regard of the future cavities of the CMUT transducers. The layers 103 and 105 are for example etched by a dry etching method, for example plasma etching. At the end of etching, the upper face of the substrate 101 is exposed around the future cavities of the CMUT transducers.

FIG. 1C illustrates the structure obtained at the end of a step of locally oxidizing the silicon of the substrate 101, also called method LOCOS (LOCal Oxidation of Silicon). During this step, is implemented a thermal oxidation of the portions of the upper face of the substrate 101 exposed at the end of the etching step of FIG. 1B. This results in growing silicon oxide walls 107 in regard of the exposed portions of the upper face of the substrate 101, i.e. around the future cavities of the CMUT transducers. The silicon nitride layer 105 however blocks the oxidation at the locations of the future cavities of the substrate 101. The height of the silicon oxide walls 107 defines the thickness or deepness of the future cavities of the CMUT transducers. More particularly, in this example, the deepness of the future cavities of the CMUT transducers corresponds to the distance between the plane of upper face of the silicon oxide walls 107 and the plane of upper face of the silicon oxide layer 103, given that the plane of upper face of the oxide walls 107 is located above the plane of upper face of the oxide layer 103. An advantage of the LOCOS method is that the height of the walls 107, and thus the deepness of the cavities, can be precisely controlled by especially controlling the temperature and the duration of the oxidation. This is particularly advantageous in performing cavities with shallow deepness, for example less than 100 nm deep, for example around 50 nm deep. The described embodiments are however not limited to cavities with shallow deepness. As an example, the deepness of the cavities of the CMUT transducers is comprised between 10 nm and 1 μm.

As a non-limitative, illustrative example, the silicon oxide layer has a thickness in the order of 125 nm, and the silicon oxide walls 107 protrude from the level of the upper face of the substrate 101 by a height of about 175 nm, so that a deepness of the cavity around 50 nm is obtained. One should note that a part of the thickness of the substrate is consumed and transformed into silicon oxide during oxidizing. for example, to obtain walls 107 protruding by about 175 nm with respect to the plane of upper face of the substrate 101, a thickness of the order of 137.5 nm of the silicon of the substrate is consumed during oxidizing, that leads to walls 107 having a whole height of the order of 312.5 nm (137.5+175 nm).

FIG. 1D illustrates the structure obtained at the end of a step of removing the silicon nitride layer 105. The layer 105 is removed by a method of selectively etching the silicon nitride with respect to the silicon oxide. The layer 105 is preferably removed by wet etching, which allows preserving the quality of the underlying silicon oxide layer 103. Particularly, this allows, compared to a dry etching method, to avoid forming micro-cracks on the upper face of the silicon oxide layer 103. At the end of this step, are kept only the silicon oxide walls 107 laterally surrounding the cavities 109 of the CMUT transducers, the silicon oxide layer 103 the upper face of which defines the bottom of the cavities 109, and the underlying substrate 101.

FIG. 1E illustrates the structure obtained at the end of a step of transferring and attaching, at the side of the upper face of the structure of FIG. 1D, a stack including, in the order starting from the upper face of the structure of FIG. 1D, a silicon oxide layer 111, a silicon layer 113, a silicon oxide layer 115, and a support layer 117, for example made of silicon. As an example, each of the layers 111, 113, 115, and 117 continuously extends with a substantially uniform thickness on the whole surface of the structure of FIG. 1D. The layers 111, 113, 115, and 117 are for example substantially flat. In this example, the substrate 117 contacts, by its lower face, the upper face of the layer 115, the layer 115 contacts, by its lower face, the upper face of the layer 113, and the layer 113 contacts, by its lower face, the upper face of the layer 111. The layer 117 for example corresponds to a silicon wafer or to a portion of silicon wafer.

The stack of the layers 111, 113, 115, and 117 is separately formed, then transferred and attached on the upper face of the structure of FIG. 1D.

As an example, the stack of the layers 117, 115, and 113 is a structure of SOI (Silicon On Insulator) type, the layer 117 constituting the support substrate of the SOI structure, the layer 115 being the buried silicon oxide layer of the SOI structure, and the layer 113 being the monocrystalline silicon active layer of the SOI structure. The thickness of the substrate 117 is for example comprised between 10 μm and 1 mm, for example between 400 and 800 μm. The thickness of the silicon oxide layer 115 is for example comprised between 50 nm and 2 μm. The thickness of the silicon layer 113 is for example comprised between 0.5 and 5 μm. The silicon layer 113 is preferably relatively highly doped. As an example, the doping level of the layer 113 is comprised between 1013 and 1018 atoms/cm3. Alternatively, the layer 113 may be unintentionally doped.

The silicon oxide layer 111 is for example formed on and contacting the lower face (in the orientation of FIG. 1E) of the silicon layer 113, before transferring the stack 111-113-115-117 on the upper face of the structure of FIG. 1D. The layer 111 is for example formed by dry-growing thermal oxidizing, for example under the same conditions as the layer 103 (FIG. 1A). The thickness of the layer 111 is for example comprised between 20 μm and 300 nm, for example between 100 and 150 nm, for example around 125 nm. Preferably, the thickness of the layer 111 is substantially equal to the thickness of the layer 103.

The stack of the layers 111, 113, 115, and 117 is then transferred and attached on the upper face of the structure of FIG. 1D. Attaching the stack is preferably performed by direct bonding, or molecular bonding, of the lower face of the silicon oxide layer 111 on the upper face of the silicon oxide walls 107, without adding any intermediary material.

To improve the quality of the bonding, an annealing

of the structure at a temperature relatively high may be provided, for example at a temperature comprised between 700 and 1,100 C. We then speak of fusion bonding.

At the end of this step, the cavities 109 of the CMUT transducers are airtight way closed. The lower face of the silicon oxide layer 111 defines the upper face of the cavities 109. The bonding may be performed under vacuum so as to obtain the cavities 109 having a pressure lower than the atmospheric pressure.

At the end of these steps, the substrate 117 and the buried silicon oxide 115 may be removed. The silicon layer 113 is kept in place and forms the membrane of the CMUT transducers. The layer 113 may further, when it is doped, form in part the higher electrode of the CMUT transducers. A conductive layer, for example in metal (not shown in FIG. 1G, corresponding to the layer 129 in the example of FIG. 1H), may further be deposited on and contacting the upper face of the semiconductor layer 113, and in part form the upper electrode of the transducers.

In this example, the substrate 101 forms the lower electrode of the CMUT transducers. Various steps of forming contact on the electrodes of the CMUT transducers and of electrically insulating the electrodes of the CMUT transducers may further be implemented. FIGS. 1F to 1I illustrate a non-limitative example implementing such steps.

FIG. 1F illustrates the structure obtained at the end of the step of thinning the substrate 101, by its lower face, and of forming contact elements at the side of the lower face of the thinned substrate 101.

As an example, the substrate 101 is thinned by grinding using the layer 117 as a handle. At the end of the step of thinning, the thickness of the substrate 101 is for example comprised between 10 and 150 μm, for example between 20 and 100 μm.

Subsequent to thinning, insulating trenches 121 are formed from the lower face of the substrate 101, in regard to silicon oxide walls 107 of the CMUT transducers. The trenches 121 vertically extend through the substrate 101, on the whole thickness of the substrate 101, and lead to the lower face of the silicon oxide walls 107.

More particularly, in this example, for each CMUT transducer elementary cell, or for each CMUT transducer element, one goes forming, at the periphery of the cell or of the element, for example at the periphery of the cavity 109 of the cell (at right-hand side of the cavity in the illustrated example), an insulating trench 121, for example ring-shaped, laterally delineating an area 123 of the substrate 101 intended to be electrically connected to the upper electrode of the transducer. In this example, the area 123 is entirely surrounded and electrically insulated from the rest of the substrate 101 by the insulating trench 121.

The trench 121 is for example filled with an electrically insulating material, for example silicon oxide. Alternatively, the side walls of the trench 121 are coated with an electrically insulating material, for example silicon oxide, then the trench is filled with an electrically insulating material, for example non-doped polysilicon or silicon oxide.

FIG. 1F further illustrates forming contact metallization on the lower face of the substrate 101. More particularly, in this example, for each CMUT transducer or for each CMUT transducer element, are formed two separate contact metallization 125a and 125b on and contacting the lower face of the substrate 101. The metallization 125a is located at the periphery of the cavity and contacts only the lower face of the area 123 of the substrate 101 electrically insulated from the rest of the substrate by the trench 121. The metallization 125b is located in regard of the cavity 109 and for example extends on most of the surface of the cavity 109, for example on substantially the whole surface of the cavity 109. The metallization 125b does not contact the area 123 of the substrate 101.

One should note that in the illustrated example, each CMUT transducer element comprises two cavities 109 (for example corresponding to two transduction elementary cells) simultaneously excited and laterally separated by a silicon oxide wall 107. The described embodiments are not limited to this specific example. Alternatively, each CMUT transducer may include a single cavity 109 or a number of cavities 109 higher than 2.

FIG. 1G illustrates the structure obtained at the end of a step of removing the support layer 117 and the silicon oxide layer 115 of the structure of FIG. 1F, so as to expose the higher face of the silicon layer 113, forming the membrane of the CMUT transducers.

FIG. 1H illustrates the structure obtained at the end of a step of forming an electrical contact on the membrane (and upper electrode) 113 of each CMUT transducer.

More particularly, in this example, one comes forming, starting from the upper face of the structure of FIG. 1G, in each CMUT transducer, just above the area 123 of the substrate 101 laterally delineated by the trench 121, an opening 127 vertically extending through the membrane 113, the silicon oxide layer 111, and the silicon oxide wall 107, and leading to the upper face of the area 123 of the substrate 101 laterally delineated by the trench 121.

One then comes forming a metallization 129 extending on and contacting the upper face of the membrane 113, in regard to the cavity 109 of the transducer, for example on most of the part of the surface of the cavity 109 or on substantially the whole surface of the cavity 109. The metallization 129 further extends on the flanges and the bottom of the opening 127. Particularly, the metallization 129 comes contacting the upper face of the area 123 of the substrate 101 laterally delineated by the trench 121. Thus, the metallization 129 is electrically connected to the lower metallization 125a of the transducer via the area 123 of the substrate 101. The metallization 129 is however electrically insulated from the rest of the substrate 101. Thus, metallization 125a and 125b are electrically coupled with the upper electrode, and with the lower electrode of the CMUT transducer, respectively. As an example, to form metallization 129, a metal layer is first deposited full wafer, on the whole upper surface of the structure, this layer being then locally etched to electrically isolate from each other the electrodes of the various transducers. In the case where the semiconductor layer 113 is doped, etching may be extended through the layer 113, so as to electrically isolate from each other the electrodes of the various transducers.

FIG. 1I illustrates the structure obtained at the end of a step of transferring and attaching the structure of FIG. 1H on a control electronic circuit 150. The electronic circuit 150 is for example an integrated circuit previously formed in and on a semiconductor substrate, for example a silicon substrate. The electronic circuit 150 is for example performed in CMOS (Complementary Metal Oxide Semiconductor) technology. The electronic circuit 150 is for example configured to, during a transmission phase, apply between the electrodes of each transducer an excitation ac voltage superimposed on a dc biasing voltage, so as to cause the transmission of an ultrasonic sound wave by the transducer, and, during a reception phase, to apply between the electrodes of each transducer a dc biasing voltage and to read between said electrodes an ac voltage generated under the influence of a received ultrasonic sound wave. The substrate on and in which is integrated the circuit 150 for example corresponds to a silicon wafer or to a portion of a silicon wafer. Thus, in this example, the transfer implemented during this step is a transfer wafer to wafer. One also speaks of assembling or packaging at the level of the wafer, or WLP, “Wafer Level Packaging”.

In the represented example, the electronic circuit 150 comprises, at the side of the upper face thereof, for each CMUT transducer of the structure of FIG. 1H, two connection metallization 151a and 151b intended to be connected to the connection metallization 125a and 125b of the transducer, respectively.

In this example, during transferring, each metallization 125a of the structure of FIG. 1H is put into contact, by its lower face, with the upper face of a corresponding metallization 151a of the electronic circuit 150, and each metallization 125b of the structure of FIG. 1H is put into contact, by its lower face, with the upper face of a corresponding metallization 151b of the electronic circuit 150. Attaching the metallization 125a, 125b to the metallization 150a, 150b may be attaching by direct bonding, by thermocompressing, by eutectic bonding, by means of a welding layer, of welding pads, of welding balls, or by any other known means for attaching and electrically connecting contact metallization.

As a not illustrated alternative, to improve the mechanical strength of the assembly during the various steps of the method, attaching the control integrated circuit 150 on the structure of CMUT transducers may be performed subsequent to the steps of FIG. 1F and before the step of removing the support layer 117 (FIG. 1G).

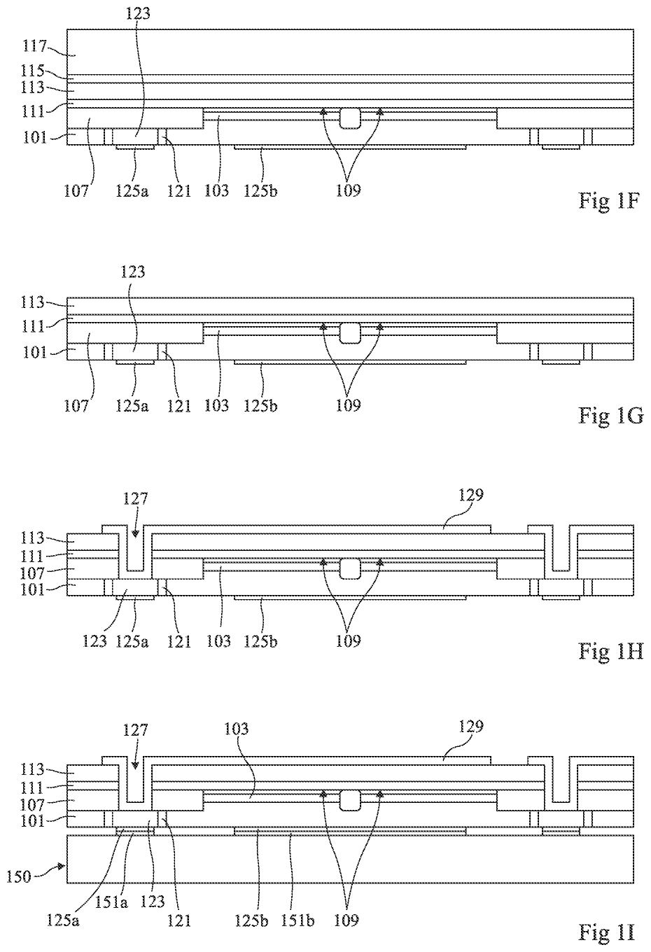

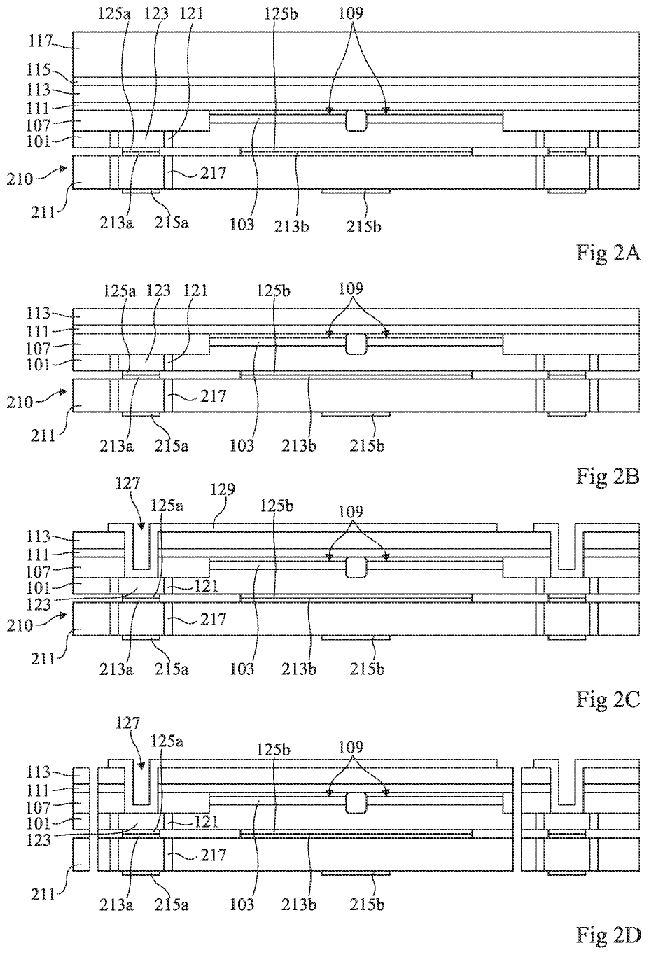

The structure of FIG. 1I may then be cut into a plurality of single chips comprising each one or more CMUT transducers, for example a CMUT transducer array, and a control electronic circuit of the one or more CMUT transducers of the chip. Cutting is for example performed by sawing, for example similarly as that was illustrated in the hereinafter described example of FIG. 2D.

FIGS. 2A to 2E illustrate another example for implementing steps of forming a contact on the CMUT transducers manufactured by the method of FIGS. 1A to 1E.

The method of FIGS. 2A to 2E differs from the method of FIGS. 1F to 1I mainly in that, in the method of FIGS. 2A to 2E, assembling the transducers and the control electronic circuit of the transducers is performed at the level of the single chip, and not at the level of the substrate or wafer (before cutting into the single chips) as in the method of FIGS. 1F to 1I.

The method of FIGS. 2A to 2F comprises steps same as or similar to those hereinabove described in relation with FIG. 1F of thinning the substrate 101, of forming insulating trenches 121 delineating connection areas 123 of the substrate, and of forming the contact metallization 125a, 125b on the lower face of the substrate 101.

FIG. 2A more particularly illustrates a step of transferring and attaching the structure of FIG. 1F on an interconnection structure 210.

The interconnection structure 210 is for example formed on and in a semiconductor substrate 211, for example a silicon substrate. The substrate 211 is preferably relatively highly doped. As an example, the substrate 211 is a silicon substrate with a doping level comprised between 1013 and 1018 atoms/cm3. The thickness of the substrate 211 is for example comprised between 30 μm and 1 mm.

The interconnection structure 210 comprises, for each CMUT transducer of the structure of FIG. 1F, two contact metallization 213a and 213b disposed on and contacting the upper face of the substrate 211, and intended to be connected to the contact metallization 125a and 125b of the transducer, respectively. The interconnection structure 210 further comprises, for each CMUT transducer of the structure of FIG. 1F, two contact metallization 215a and 215b disposed on and contacting the lower face of the substrate 211, for example just above the contact metallization 213a and 213b, respectively. The interconnection structure 210 further comprises vertical insulating trenches 217, for example similar to the trenches 121 of the structure of FIG. 1F, extending in the whole thickness of the substrate 211. The trenches 217 are arranged so that, for each CMUT transducer, the connection metallization 213a and 215a associated with the transducer are electrically coupled with each other by an area of the substrate 211, and are electrically insulated from the contact metallization 213b and 215b of the transducer and also from the contact metallization 213a, 215a, 213b, 215b of the other transducers.

The interconnection structure 210 may be separately performed, then transferred and attached on the lower face of the structure of FIG. 1F. Transferring is for example performed at the level of the substrate or wafer (WLP).

In this example, during transferring, each metallization 125a of the structure of FIG. 1F is put into contact, by its lower face, with the upper face of a corresponding metallization 213a of the interconnection structure 210, and each metallization 125b of the structure of FIG. 1H is put into contact, by its lower face, with the upper face of a corresponding metallization 213b of the interconnection structure 210. Attaching metallization 125a, 125b to metallization 213a, 213b may be attaching by direct bonding, by thermocompressing, by means of a welding layer, of welding pads, of welding balls, or by any other known means for attaching and electrically connecting contact metallization.

FIG. 2B illustrates the structure obtained at the end of a step of removing the support layer 117 and of the silicon oxide layer 115 of the structure of FIG. 2A, so as to expose the upper face of the silicon layer 113, forming the membrane of the CMUT transducers.

FIG. 2C illustrates the structure obtained at the end of a step of forming an electrical contact on the membrane (and upper electrode) 113 of each CMUT transducer. This step is similar to that was hereinabove described in relation with FIG. 1H.

FIG. 2D illustrates a step of cutting the structure of FIG. 2C into a plurality of single chips comprising each one or more CMUT transducers, for example an array of CMUT transducers, and a corresponding portion of the interconnection structure 210. Cutting is for example performed by sawing.

Each single chip may then be attached and electrically connected to a control electronic circuit, for example an integrated circuit chip having side dimensions lower than those of the transducer.

FIG. 2E illustrates the structure obtained at the end of a step of transferring and attaching a transducer chip obtained at the end of the step of FIG. 2D, on a control electronic circuit 250 chip previously formed from a semiconductor substrate, for example a silicon substrate. The electronic circuit 250 is for example performed in CMOS technology. In the represented example, the electronic circuit 250 comprises, at the side of its upper face, for each CMUT transducer of the transducer chip, two connection metallization 251a and 251b, intended to be connected to the connection metallization 215a and 215b of the transducer chip, respectively.

The metallization 215a, 215b of the transducer chip are connected to the metallization 251a, 251b of the control chip by any suitable connecting means, for example by direct bonding, by thermocompressing, by means of a welding layer, of welding pads, of welding balls, etc.

An advantage of the embodiment of FIGS. 2A to 2E is that the interconnection structure 210 can allow, to some extent, the arrangement of the contacts of the CMUT (125a and 125b) to be adapted to different arrangements of the contacts of the CMOS (in regard to the contacts 215a and 215b). Thus, for a same design of CMUT transducer, one may adapt to different CMOS circuits by only modifying the design of the interconnection structure 210, generally easier to manufacture. Thus, although on the figures are metallization 215a, 215b and insulating trenches 217 vertically aligned on the metallization 125a, 125b and on the insulating trenches 121, respectively, in practice the metallization 215a, 215b and insulating trenches 217 may be not vertically aligned on the metallization 125a, 125b and on the insulating trenches 121, as illustrated for example in FIG. 2F.

Another advantage of the interconnection structure 210 is it allows adding rigidity to the assembly CMUT+interconnection structure after removing the support layer 117 and before transferring the control circuits.

An advantage of the embodiments described in relation with FIGS. 1A-1I, 2A-2F, and 2F is that the silicon oxide layers 103 and 111 located at the lower face side and at the upper face side of the cavity 109, respectively, have a high quality on the one hand because they are performed by a full-wafer dry-growing thermal-oxidizing method allowing a high quality oxide to be obtained, and on the other hand because they undergo no step of etching or partially etching the thickness during the method. It allows the parasitic phenomenon of injecting or trapping electrical charges in the layers 103 and 111, possibly deteriorating the operation of the transducers, to be restricted.

Preferably, the layers 103 and 111 have the same or substantially the same thickness that allows the structure to be symmetric, and the balancing of the distribution of the charges injected in the layers 103 and 111 to be promoted.

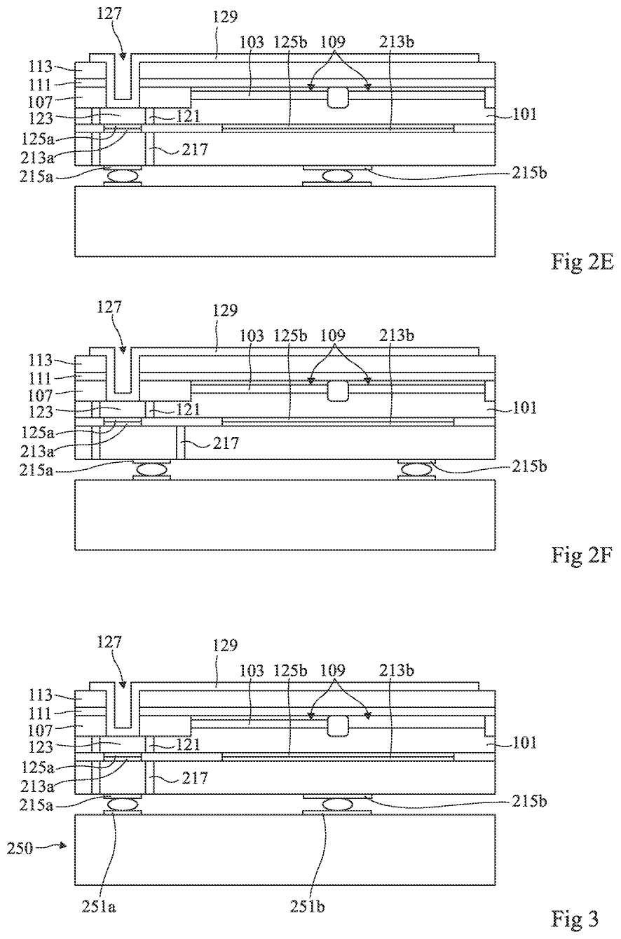

FIG. 3 is a cross-sectional view illustrating an alternative embodiment of the device of FIG. 2E.

In such an alternative, the dielectric layer 103 was removed in one of the two cavities 109 of the CMUT transducer and kept in place in the other cavity. It allows two different height of cavity to be obtained, for example for two cavities having different shapes or side dimensions, on a same substrate. Particularly, the lack of the layer 103 in one of the cavities allows benefiting from a higher displacement of the membrane and thus using a membrane having a greater surface. This allows, for example, a transducer adapted to simultaneously transmit at two separate sound frequencies to be obtained. Locally etching the layer 103 is for example implemented after the step of removing the silicon nitride layer 105 (FIG. 1D) and before closing the cavities 109 by bonding the silicon oxide layer 111 of the membrane 113 (FIG. 1E).

The alternative of FIG. 3 can of course be combined with the method of FIGS. 1F-1I. Various embodiments and variants have been described. Those skilled in the art will understand that certain features of these embodiments can be combined and other variants will readily occur to those skilled in the art. In particular, the described embodiments are not limited to the dimension examples exposed in the present disclosure.

Furthermore, one should note that in the hereinabove described examples, the silicon oxide walls 107 laterally delineating the cavities 109 of the transducers are formed by a LOCOS method on the upper face of the substrate 101, forming the lower electrode of the transducers. As an alternative, the walls 107 may be formed by a LOCOS method on the lower face of the silicon layer 113, forming the membrane and the upper electrode of the transducers. In this case, the lower silicon oxide layer 103 of the structure is not etched. The silicon nitride layer 105 is then formed on the lower face (in the orientation of FIG. 1E) of the oxide layer 111, and the stack of the layers 111 and 105 is locally etched to be kept in place only in regard of the future cavities 109 of the transducers.

In another alternative, the LOCOS method may be implemented at the side of the lower face of the membrane and at the side of the upper face of the substrate 101, before transferring the membrane on the substrate 101. In this case, it will be appropriate to align the lower portions of the walls 107 with the upper portions of the walls 107 during transferring.

Finally, the practical implementation of the embodiments and variants described herein is within the capabilities of those skilled in the art based on the functional description provided hereinabove.

1. A method of manufacturing a CMUT transducer, comprising the following steps:
a) forming a first silicon oxide layer on a face of a first silicon layer defining a first electrode of the transducer;
b) forming a second silicon oxide layer on a face of a second silicon layer;
c) subsequent to step a), forming at the side of said face of the first silicon layer, by locally etching the silicon of the first silicon layer, silicon oxide walls having a height higher than the thickness of the first silicon oxide layer, said walls laterally delineating a cavity of the transducer; and
d) subsequent to steps b) and c), transferring and attaching the set comprising the second silicon layer and the second silicon oxide layer on the set comprising the first silicon layer, the first silicon oxide layer, and the silicon oxide walls, so as to close the cavity of the transducer, said cavity vertically extending from the face of the first silicon oxide layer opposite to the first silicon layer to the face of the second silicon oxide layer opposite to the second silicon layer.

2. The method according to claim 1, wherein in step a), the first silicon oxide layer is formed by dry-growing thermal oxidizing said face of the first silicon layer, and, in step b), the second silicon oxide layer is formed by dry-growing thermal oxidizing said face of the second silicon layer.

3. The method according to claim 1, wherein step c) comprises a step of depositing a silicon nitride layer on the face of the first silicon oxide layer opposite to the first silicon layer, followed with a step of locally etching the silicon nitride layer and the first silicon oxide layer at the desired locations of the silicon oxide walls, followed with a step of thermally oxidizing so as to form the silicon oxide walls, followed with a step of removing the silicon nitride layer.

4. The method according to claim 3, wherein removing the silicon nitride layer is performed by wet etching.

5. The method according to claim 1, wherein in step d), the set comprising the second silicon layer and the second silicon oxide layer is attached on the set comprising the first silicon layer, the first silicon oxide layer, and the silicon oxide walls by direct bonding.

6. The method according to claim 5, wherein the direct bonding implemented in step d) comprises an annealing at a temperature comprised between 700 and 1,100° C.

7. The method according to claim 5, wherein the direct bonding implemented in step d) is a bonding of the face of the second silicon oxide layer opposite to the second silicon layer on the face of the silicon oxide walls opposite to the second silicon oxide layer.

8. The method according to claim 1, wherein the first silicon layer is a fixed substrate, and the second silicon layer is a flexible membrane of the transducer.

9. The method according to claim 1, wherein the thickness of the first silicon oxide layer is substantially equal to the thickness of the second silicon oxide layer.

10. The method according to claim 1, further comprising steps of forming, on the face of the first silicon layer opposite to the first silicon oxide layer, contact metallisation of the transducer, and a step of connecting said contact metallisation with a control integrated circuit of the transducer.

11. The method according to claim 1, wherein the first silicon layer is doped.

12. The method according to claim 1, comprising a step of forming, on a face of the second silicon layer opposite to the second silicon oxide layer, a metal layer defining a second electrode of the transducer.

13. A CMUT transducer comprising:
a first silicon layer defining a first electrode of the transducer;
a first silicon oxide layer disposed on and contacting the upper face of the first silicon layer;
silicon oxide localised walls vertically extending higher than the upper face of the first silicon oxide layer and partially entering the first silicon layer, said walls laterally delineating a cavity of the transducer;
a second silicon oxide layer closing the cavity at its upper face, the cavity vertically extending from the upper face of the first silicon oxide layer to the lower face of the second silicon oxide layer; and
a second silicon layer disposed on and contacting the upper face of the second silicon oxide layer.
